(19) United States
(12) Patent Application Publication
(10) Pub. No.: US 2026/0288649 A1
(43) Pub. Date: Sep. 24, 2026

(54) ELECTRONIC DEVICE AND METHOD FOR MANAGING MICRO-OPERATIONS

(71) Applicant: Shanghai Zhaoxin Semiconductor Co., Ltd., Shanghai (CN)

(72) Inventors: Weilin WANG, Beijing (CN); Yingbing GUAN, Shanghai (CN); Long CHENG, Shanghai (CN)

(21) Appl. No.: 19/318,608

(22) Filed: Sep. 4, 2025

(30) Foreign Application Priority Data
Mar. 20, 2025 (CN) 202510328999.0

(51) Int. Cl. G06F 12/1045; G06F 12/121

(52) U.S. Cl. CPC G06F 12/1045; G06F 12/121

(57) ABSTRACT

A method for managing micro-operations is provided. The method includes determining whether a translation buffer and a micro-operation cache store a micro-operation corresponding to a translation instruction using a processing unit, when the processing unit executes the translation instruction. The method includes outputting a certain micro-operation to enter a system management mode using the processing unit, when the translation buffer and the micro-operation cache don’t store the micro-operation corresponding to the translation instruction. The method includes translating the translation instruction into the micro-operation corresponding to the translation instruction in the system management mode using the processing unit. The method includes storing the micro-operation corresponding to the translation instruction into the micro-operation cache using the processing unit.

### CROSS REFERENCE TO RELATED APPLICATIONS

This Application claims priority of China Patent Application No. 202510328999.0, filed on Mar. 20, 2025, the entirety of which is incorporated by reference herein.

### TECHNICAL FIELD

The present invention relates to the translation of instructions, and, in particular, it relates to method for storing the micro-operations generated after the translation.

### BACKBGOUND

Micro-operations (also referred to as μop or uop) are detailed low-level instructions. A micro-operation may be the simplest operation executed by a processing unit. A complicated machine instruction can be transformed in to multiple micro-operations, to cause the processing unit to implement the machine instruction by executing the micro-operations. The transformed micro-operations can be stored for reuse. However, how to store as many micro-operations as possible in a limited storage space is a problem to be solved in the art.

### BRIEF SUMMARY

Embodiments of the present disclosure provide an electronic device, comprising a memory, a micro-operation cache, and a processing unit. The memory comprises a translation buffer. The processing unit is configured to determine whether the translation buffer and the micro-operation cache store a micro-operation corresponding to a translation instruction, when executing the translation instruction. The processing unit is further configured to output a certain micro-operation to enter a system management mode, when the translation buffer and the micro-operation cache don’t store the micro-operation corresponding to the translation instruction. The processing unit is further configured to translate the translation instruction into the micro-operation corresponding to the translation instruction in the system management mode. The processing unit is further configured to store the micro-operation corresponding to the translation instruction into the micro-operation cache.

Embodiments of the present disclosure provide a method for managing micro-operations. The method comprises determining whether a translation buffer and a micro-operation cache store a micro-operation corresponding to a translation instruction using a processing unit, when the processing unit executes the translation instruction. The method comprises outputting a certain micro-operation to enter a system management mode using the processing unit, when the translation buffer and the micro-operation cache don’t store the micro-operation corresponding to the translation instruction. The method comprises translating the translation instruction into the micro-operation corresponding to the translation instruction in the system management mode using the processing unit. The method comprises storing the micro-operation corresponding to the translation instruction into the micro-operation cache using the processing unit.

### BRIEF DESCRIPTION OF THE DRAWINGS

The present disclosure can be more fully understood by reading the subsequent detailed description and examples with references made to the accompanying drawings, wherein:

FIG. 1 is a block diagram of the electronic device in accordance with the embodiments of the present disclosure;

FIG. 2 is a flow diagram of the method for managing the micro-operation in accordance with embodiments of the present disclosure; and

FIG. 3 is a flow diagram of a method for managing the micro-operation in accordance with embodiments of the present disclosure.

### DETAILED DESCRIPTION

The following description is made for the purpose of illustrating the general principles of the disclosure and should not be taken in a limiting sense. The scope of the disclosure is best determined by reference to the appended claims.

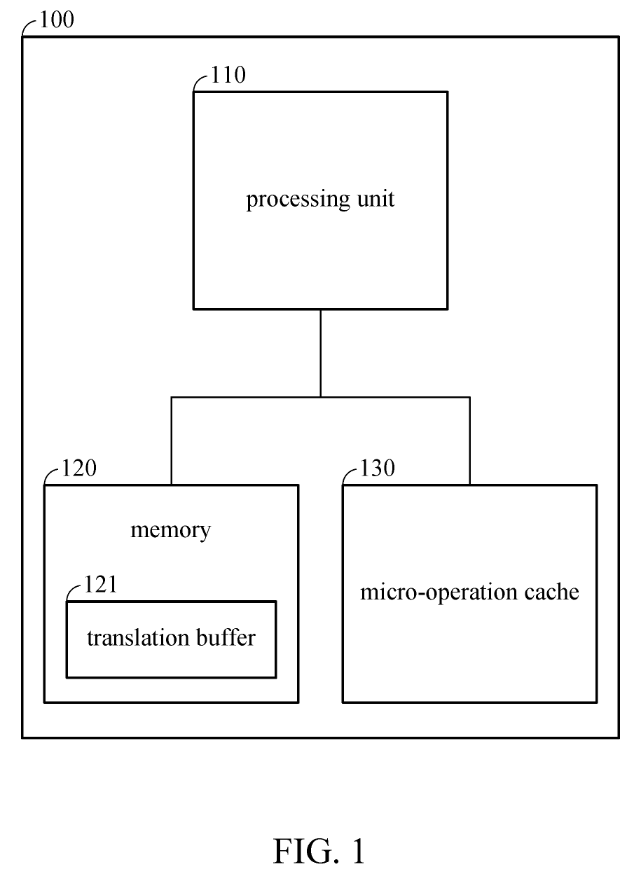

Refer to FIG. 1, which is a block diagram of the electronic device 100 in accordance with the embodiments of the present disclosure. The electronic device 100 comprises a processing unit 110, a memory 120, and a micro-operation cache (also referred to as μop cache or uop cache) 130. The electronic device 100 may be a calculation device, a mobile device, a wearable device, or an Internet-of-things device. For example, the electronic device 100 may be a desktop computer, a laptop, a tablet computer, a smartphone, or other similar devices.

The processing unit 110 provides the capability to calculate and process the data. The processing unit 110 is able to execute programs, software, firmware, module, and operating systems. In some embodiments, the processing unit 110 is implemented with one or more integrated circuit. In some embodiments, the processing unit 110 is implemented with multiple electronic components, comprising transistors, diodes, capacitors, resistors, or inductors. These electronic components are configured to implement the specific purpose of the embodiments in accordance with the present disclosure. For example, the processing unit 110 may comprise a general-purpose processor, a special-purpose processor, a central processing unit, an instruction set processor, and/or a micro-controller unit.

The memory 120 may comprise non-volatile memory, such as read-only memory and flash memory. The memory 120 may also comprise volatile memory, such as dynamic random-access memory and static random-access memory. The memory 120 comprises a translation buffer 121. The translation buffer 121 and the micro-operation cache 121 are configured to store micro-operations output from an instruction decode unit. The instruction decode unit is configured to translate the instruction into micro-operation. Translation is an instruction decoding technology, which is configured to transform an instruction into target instruction, such as micro-operation. The instruction and micro-operation are program instruction or machine language configured to instruct the processing unit 110 to execute operations such as moving the data, arithmetic calculation, or logical calculation. The micro-operation is detailed low-level instruction. Micro-operation may be the simplest operation executed by the processing unit 110. A complicated machine instruction may be transformed into multiple micro-operations, to cause the processing unit 110 to implement the machine instruction via executing the micro-operations. In some embodiments, the instruction decode unit is a hardware component similar to the processing unit 110. In other embodiments, the instruction decode unit is a software module. For example, the processing unit 110 executes program instructions to implement said software module. In some embodiments, the micro-operation cache 130 is integrated in the memory 120. Performing translation requires the processing unit 110 to enter the system management mode and maintain a translation buffer 121 in the system management mode. In the system management mode, the translation instruction is translated into the micro-operation. The translated micro-operation may be stored into the translation buffer 121 to be reused. When the same translation instruction is performed again, the processing unit 110 determines whether the translation buffer 121 stores the micro-operation corresponding to the translation instruction. When the translation buffer 121 stores the micro-operation corresponding to the translation instruction, the processing unit 110 reads and performs the corresponding micro-operation. However, the storage capacity of the translation buffer 121 is limited. The contents stored in the translation buffer 121 will be replaced gradually. When the translation buffer 121 doesn’t store the micro-operation corresponding to the translation instruction, the translation has to be performed again. This will cost a large amount of time.

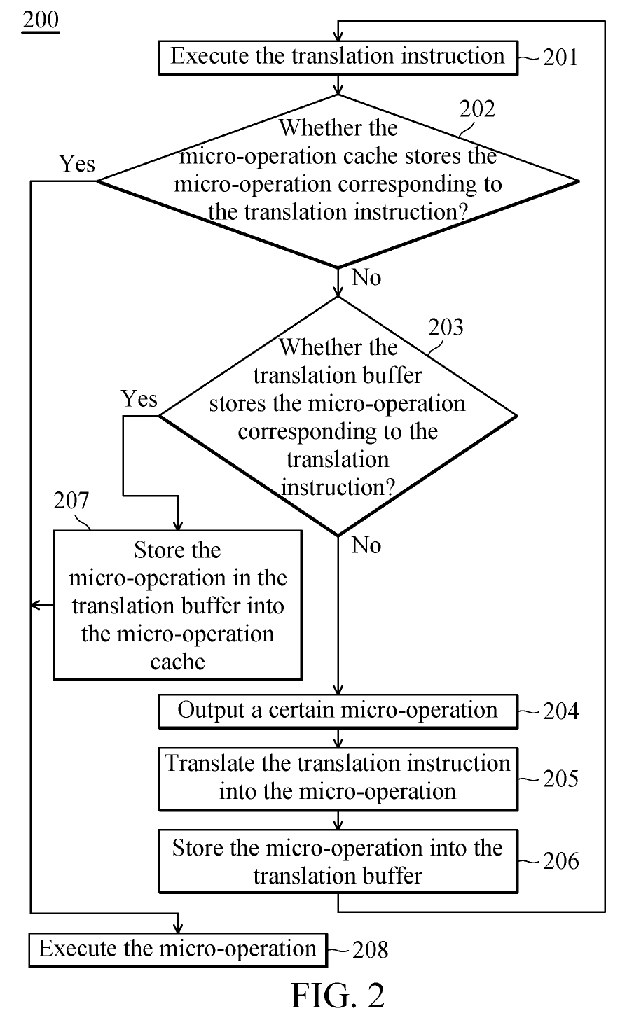

Refer to FIG. 2, which is a flow diagram of the method 200 for managing the micro-operation in accordance with embodiments of the present disclosure. Method 200 may be implemented in the electronic device 100. In operation 201, the processing unit 110 executes the translation instruction. The instruction set of the processing unit 110 comprises an encoding space, and the encoding space comprises multiple instructions. In some embodiments, this encoding space of the instruction set is an encoding space kept unused in an older processing unit and is configured to allow the older processing unit to perform functions added in the future. For example, these instructions are machine languages. When these instructions are used by software or programs, it triggers the processing unit to perform method 200, in order to search the micro-operation corresponding to these instructions or translate these translation instructions into at least one micro-operation. In the present disclosure, these instructions may be referred to as the translation instruction.

When the processing unit 110 performs the translation instruction, the processing unit 110 performs operations 202 and 203. In operation 202, the processing unit 110 determines whether the micro-operation cache 130 stores the micro-operation corresponding to the translation instruction. When the micro-operation cache 130 stores the micro-operation corresponding to the translation instruction, the processing unit 110 performs operation 208. When the micro-operation cache 130 doesn’t store the micro-operation corresponding to the translation instruction, the processing unit 110 performs operation 203. In operation 203, the processing unit 110 determines whether the translation buffer 121 stores the micro-operation corresponding to the translation instruction. When the translation buffer 121 stores the micro-operation corresponding to the translation instruction, the processing unit performs operation 207. When the translation buffer 121 doesn’t store the micro-operation corresponding to the translation instruction, the processing unit performs operation 204. In some embodiments, first, the processing unit 110 searches for the micro-operation corresponding to the translation instruction in the micro-operation cache 130. Then, when the micro-operation cache 130 doesn’t store the micro-operation corresponding to the translation instruction, the processing unit 110 searches for the micro-operation corresponding to the translation instruction in the translation buffer 121. When neither the micro-operation cache 130 and the translation buffer 121 stores the micro-operation corresponding to the translation instruction (e.g. when it is the first time that the translation instruction is performed, and thus the translation instruction has never been translated), the processing unit 110 performs operation 204 to perform the translation procedure.

In operation 204, the processing unit 110 outputs a certain micro-operation. The certain micro-operation is configured to trigger the system management interrupt (SMI) in the processing unit 110 so as to make the processing unit 110 enter the system management mode (SMM). In operation 205, the processing unit 110 translates the translation instruction into at least one micro-operation corresponding to the translation instruction (e.g. using the instruction translation unit) in the SMM. In some embodiments, the instruction translation unit is a dedicated hardware unit designed specifically for the translation of the translation instruction, rather than a regular instruction translation unit. In detail, the instruction translation unit uses a special x86 instruction output from the handler of the SMM to trigger the component in the processing unit 110 to generate the micro-operation corresponding to the translation instruction and store the micro-operation into the translation buffer 121. In operation 206, the processing unit 110 stores the micro-operation corresponding to the translation instruction into the translation buffer 121 and exits the SMM. In some embodiments, the processing unit 110 stores the micro-operation into the translation buffer 121 first and then exits the SMM. In other embodiments, the processing unit 110 exits the SMM first and then stores the micro-operation into the translation buffer 121.

After exiting the SMM, the processing unit 110 performs operation 201. In other words, after exiting the SMM, the processing unit 110 executes the translation instruction again. Then, the processing unit 110 performs operations 202 and 203. Because the micro-operation corresponding to the translation instruction has been stored in the translation buffer 121 but hasn’t been stored in the micro-operation cache 130, the processing unit 110 performs operation 207. In operation 207, the processing unit 110 stores the micro-operation, which is in the translation buffer 121, corresponding to the translation instruction into the micro-operation cache 130. Then, the processing unit 110 performs operation 208. In operation 208, the processing unit 110 executes the micro-operation corresponding to the translation instruction.

After the processing unit 110 has performed operations 204, 205, 206, 207, the micro-operation cache 130 stores the micro-operation corresponding to the translation instruction. Thus, when the translation instruction is executed again, the processing unit 110 can execute the micro-operation corresponding to the translation instruction in the micro-operation cache 130 without performing the translation procedure again. In other words, the processing unit 110 performs operations 201, 202, 208 in order.

In some embodiments, the processing unit 110 doesn’t store the certain micro-operation in the translation buffer 121 or the micro-operation cache 130, because the certain micro-operation triggers SMI and makes the processing unit 110 enter the SMM. If the certain micro-operation is stored into the translation buffer 121 or the micro-operation cache 130, each subsequent execution of the translation instruction will cause the processing unit 110 to enter SMM. This increases the latency of executing the translation instruction.

In some embodiments, the micro-operation cache 130 comprises a counter. The count value of the counter indicates the number of micro-operations corresponding to the translation instruction stored in the micro-operation cache 130. As described above, the translation instructions are the instructions that belong to the same encoding space in the instruction set of the processing unit 110. The micro-operation cache 130 is also configured to store micro-operations of the instructions in other encoding spaces. When the count value is higher than the threshold, the processing unit 110 doesn’t store the micro-operation corresponding to the translation instruction into the micro-operation cache 130. When the count value is lower than the threshold, the processing unit 110 stores the micro-operation corresponding to the translation instruction into the micro-operation cache 130. In some embodiments, the threshold is configured by a model specific register (MSR), and the software may adjust the threshold through the MSR. In some embodiments, the threshold is adjusted by the hardware component. In some embodiments, the processing unit 110 is configured to adjust the threshold based on the number of micro-operations stored in the micro-operation cache 130 and the count value. The processing unit 110 adjusts the threshold based on the number of all the micro-operations stored in the micro-operation cache 130 and the number of all the micro-operations corresponding to the translation instruction stored in the micro-operation cache 130.

In some embodiments, the processing unit 110 is configured to store the micro-operation in the translation buffer 121 into the micro-operation cache 130. The processing unit 110 is further configured to store the micro-operation in the micro-operation cache 130 into the translation buffer 121. Thus, the micro-operations being replaced in the translation buffer 121 can be stored into the micro-operation cache 130. The micro-operations being replaced in the micro-operation cache 130 can be stored into the translation buffer 121. This can increase the total number of micro-operations that can be stored.

Embodiments of the present disclosure can increase the number of micro-operations that can be stored by storing the micro-operation corresponding to the translation instruction into the micro-operation cache 130. Furthermore, using the micro-operation cache 130 to store the micro-operation corresponding to the translation instruction helps to decrease the area and power consumption of the translation buffer 121. Even if the micro-operation in the translation buffer 121 is replaced because of the capacity limit, the micro-operation cache 130 still stores the micro-operation corresponding to the translation instruction. This allows the processing unit 110 to skip the translation procedure and execute the instruction by reading the micro-operation in the micro-operation cache 130. Furthermore, embodiments of the present disclosure can avoid frequently replacing the contents of the translation buffer 121 because of the small capacity of the translation buffer 121. Thus, embodiments of the present disclosure can improve the efficiency of executing the instruction.

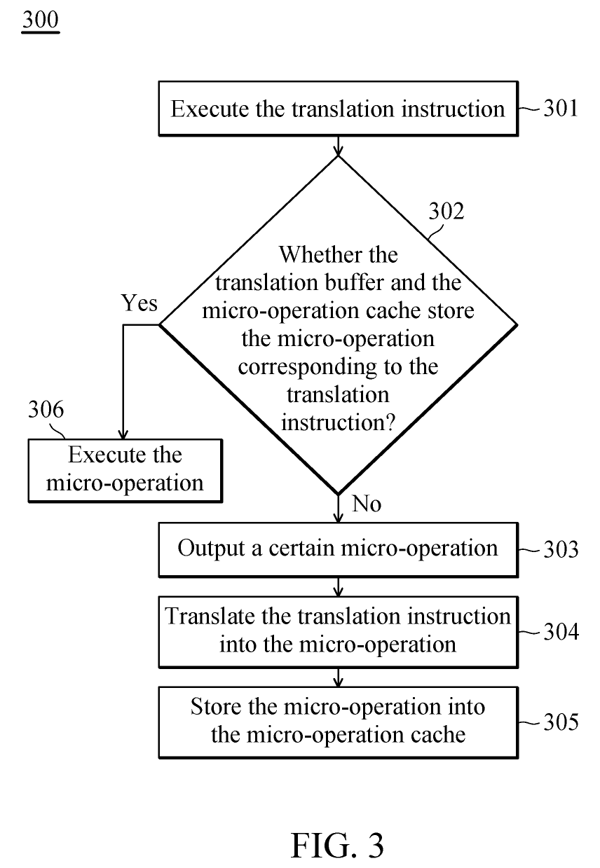

Refer to FIG. 3, which is a flow diagram of a method 300 for managing the micro-operation in accordance with embodiments of the present disclosure. The method 300 may be implemented in the electronic device 100. In operation 301, the processing unit 110 executes the translation instruction. In operation 302, when the processing unit 110 executes the translation instruction, the processing unit 110 determines whether the translation buffer 121 and the micro-operation cache 130 store the micro-operation corresponding to the translation instruction. When the translation buffer 121 and the micro-operation cache 130 store the micro-operation corresponding to the translation instruction, the processing unit 110 performs operation 306. In operation 306, the processing unit executes the micro-operation corresponding to the translation instruction. When the translation buffer 121 and the micro-operation cache 130 don’t store the micro-operation corresponding to the translation instruction, the processing unit 110 performs operation 303. In operation 303, the processing unit 110 outputs the certain micro-operation to enter the system management mode. In operation 304, the processing unit 110 translates the translation instruction into the micro-operation corresponding to the translation instruction. In operation 305, the processing unit 110 stores the micro-operation corresponding to the translation instruction into the micro-operation cache 130. In some embodiments, operation 305 is performed after the processing unit 110 exits the system management mode.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. An electronic device, comprising:
a memory, comprising a translation buffer;
a micro-operation cache; and
a processing unit, configured to:
determine whether the translation buffer and the micro-operation cache store a micro-operation corresponding to a translation instruction, when executing the translation instruction;
when the translation buffer and the micro-operation cache don’t store the micro-operation corresponding to the translation instruction, output a certain micro-operation to enter a system management mode;
translate the translation instruction into the micro-operation corresponding to the translation instruction in the system management mode; and
store the micro-operation corresponding to the translation instruction into the micro-operation cache.

2. The electronic device as claimed in claim 1, wherein the processing unit is further configured to:
store the micro-operation corresponding to the translation instruction into the translation buffer;
execute the translation instruction again after exiting the system management mode; and
when the translation buffer stores the micro-operation corresponding to the translation instruction, store the micro-operation corresponding to the translation instruction in the translation buffer into the micro-operation cache.

3. The electronic device as claimed in claim 1, wherein the processing unit is further configured to:
when the micro-operation cache stores the micro-operation corresponding to the translation instruction, execute the micro-operation corresponding to the translation instruction.

4. The electronic device as claimed in claim 1, wherein the processing unit doesn’t store the certain micro-operation into the translation buffer or the micro-operation cache.

5. The electronic device as claimed in claim 1, wherein the micro-operation cache comprises a counter, a count value of the counter indicates a number of micro-operations corresponding to the translation instruction stored in the micro-operation cache;
wherein the processing unit doesn’t store the micro-operation corresponding to the translation instruction into the micro-operation cache, when the count value is higher than a threshold; and
the processing unit stores the micro-operation corresponding to the translation instruction into the micro-operation cache, when the count value is lower than the threshold.

6. The electronic device as claimed in claim 5, wherein the processing unit is further configured to adjust the threshold based on a number of micro-operations stored in the micro-operation cache and the count value.

7. The electronic device as claimed in claim 1 wherein the processing unit is further configured to:
store a micro-operation in the translation buffer into the micro-operation cache; or
store the micro-operation in the micro-operation cache into the translation buffer.

8. A method for managing micro-operations, comprising:
determining, via a processing unit, whether a translation buffer and a micro-operation cache store a micro-operation corresponding to a translation instruction, when the processing unit executes the translation instruction;
outputting, via the processing unit, a certain micro-operation to enter a system management mode, when the translation buffer and the micro-operation cache don’t store the micro-operation corresponding to the translation instruction;
translating, via the processing unit, the translation instruction into the micro-operation corresponding to the translation instruction in the system management mode; and
storing, via the processing unit, the micro-operation corresponding to the translation instruction into the micro-operation cache.

9. The method as claimed in claim 8, further comprising:
storing, via the processing unit, the micro-operation corresponding to the translation instruction into the translation buffer;
executing, via the processing unit, the translation instruction again, after exiting the system management mode; and
storing, via the processing unit, the micro-operation corresponding to the translation instruction in the translation buffer into the micro-operation cache, when the translation buffer stores the micro-operation corresponding to the translation instruction.

10. The method as claimed in claim 8, further comprising:
executing, via the processing unit, the micro-operation corresponding to the translation instruction, when the micro-operation cache stores the micro-operation corresponding to the translation instruction.

11. The method as claimed in claim 8, wherein the processing unit doesn’t store the certain micro-operation into the translation buffer or the micro-operation cache.

12. The method as claimed in claim 8, wherein the micro-operation cache comprises a counter, and a count value of the counter indicates a number of the micro-operations corresponding to the translation instruction stored in the micro-operation cache;
wherein the method further comprises:
not storing, via the processing unit, the micro-operation corresponding to the translation instruction into the micro-operation cache, when the count value is higher than a threshold; and
storing, via the processing unit, the micro-operation corresponding to the translation instruction into the micro-operation cache, when the count value is lower than the threshold.

13. The method as claimed in claim 12, further comprising:
adjusting, via the processing unit, the threshold based on a number of micro-operations stored in the micro-operation cache and the count value.

14. The method as claimed in claim 8, further comprising:
storing, via the processing unit, a micro-operation in the translation buffer into the micro-operation cache; or
storing, via the processing unit, a micro-operation in the micro-operation cache into the translation buffer.
